(19) United States
(12) Patent Application Publication
(10) Pub. No.: US 2024/0128824 A1
(43) Pub. Date: Apr. 18, 2024

(54) Dynamo-Electric Machine

(71) Applicant: Hitachi Industrial Equipment Systems Co., Ltd., Chiyoda-ku, Tokyo (JP)

(72) Inventors: Kenji IKEDA, Tokyo (JP); Yuji ENOMOTO, Tokyo (JP); Hirooki TOKOI, Tokyo (JP); Mizuki NAKAHARA, Tokyo (JP); Hiroyuki MIKAMI, Tokyo (JP); Toshifumi SUZUKI, Tokyo (JP); Toru SAKAI, Tokyo (JP); Masaru AMAIKE, Tokyo (JP); Yuji TSUJI, Tokyo (JP)

(21) Appl. No.: 18/276,099

(22) PCT Filed: Dec. 16, 2021
(86) PCT No.: PCT/JP2021/046651

§ 371 Date: Aug. 7, 2023

(30) Foreign Application Priority Data
Feb. 8, 2021 (JP) 2021-018636

(51) Int. Cl. H02K 3/40

(52) U.S. Cl. CPC H02K 3/40

(57) ABSTRACT

A dynamo-electric machine comprising: a stator core with plurality of slots, a coil covered with insulated conductor wire, wherein the coil comprising plurality of storages stored in the slots and plurality of coil ends that are outside of the slots, conductor of coil end close to the conductor of the heterophase coil having insulating materials at only one of the surfaces, either the inner diameter surface close to the conductor of the heterophase coil or outer diameter surface of the heterophase coil.

### TECHNICAL FIELD

This invention relates to dynamo-electric machines.

### BACKGROUND ART

While there is a demand for miniaturization of dynamo-electric machines, there is also a need to improve their electrical insulation properties. An effective means of miniaturization is to increase the winding occupancy ratio of the stator to achieve high power density. To improve the winding occupancy, a stator structure using segment coils, such as flat wires, has been proposed. segment coils have a U-shape and consist of a pair of straight sections and a continuous inclined section.

The straight sections of the segment coil are each housed in a slot in the stator core, and the U-shape of the segment coil protrudes from the end of the stator core in the direction of the stator core axis.

The pair of straight portions are bent at the opposite end of the stator core axis with respect to the inclined portion provided for a schematic U-shape, and the other inclined portion is formed.

The inclined portion of the segment coil is welded with the inclined portion of another segment coil similarly formed and continuously connected with a predetermined number of segment coils to form the coil end of the stator coil.

Since the different phases of the segment coil are adjacent to each other at the sloping part of the coil end, there was a concern that dielectric breakdown would easily occur if the insulation strength of the enamel insulation film provided on the segment coil became low due to long-term use. Similarly, at the welding position of the inclined section of the coil end, the conductor is exposed, and if insulation reinforcement is not provided at the welding position, dielectric breakdown will occur.

Patent documents 1 and 2 disclose technologies to improve these reductions in insulation strength.

### CITATION LIST

### Patent Document

[Patent Document 1] Unexamined Japanese Patent Publication No. 2014-161212
[Patent Document 2] Unexamined Japanese Patent Publication No. 2018-117466

### SUMMARY OF THE INVENTION

### Problems to be Solved by the Invention

The stator of the dynamo-electric machine disclosed in Patent Literature 1 secures the insulation strength between different phases by placing insulators at multiple locations in the axial and radial directions at the adjacent locations of the different phases of the segment coil at the coil end. In the technique of placing insulators as described in the Patent literature 1, it is necessary to provide a dimensional margin that allows the segment coil with insulators to be inserted into the slot, and there is a concern that the stator dimensions may become larger. Similarly, there was a concern that the coil end diameter would increase due to the placement of insulators at multiple locations.

The stator of the dynamo-electric machine disclosed in the patent document 2 has a structure that uses segment coils without insulation coating at the welding position of the coil end, and therefore, in the space between segment coils of different phases adjacent to each other in the axial direction, insulation strength between the different phases is secured by placing insulation in the axial direction of the segment coils with exposed conductors.

Since the insulator is placed in the axial direction of the segment coil in a very small space by retrofitting, there were concerns that the insulating performance would deteriorate due to the low mounting accuracy of the insulator, the diameter would increase in the radial direction, and the man-hours required for installation would increase.

The patent document 2 only places insulators on the exposed part of the conductor at the welding position of the coil end, and there is no disclosure regarding the placement of insulators on a segment coil whose conductor is insulated and coated with insulation.

The inventor has found that the initial and long-term insulation reliability can be improved by placing an insulating material on one side of the inner or outer diameter of the conductors at the stator coil end where insulation-coated conductors of different phases adjoin each other.

Furthermore, they found that by placing insulation on one side of the inner or outer diameter of the conductor wider than the width of the conductor, the creepage discharge characteristics between adjacent dissimilar-phase conductors can also be improved.

The purpose of this invention is to provide a dynamo-electric machine with improved insulation reliability at the coil end using less material and a simple construction method.

One preferred example of this invention has a dynamo-electric machine comprising: a stator core with plurality of slots, a coil covered with insulated conductor wire, wherein the coil comprising plurality of storages stored in the slots and plurality of coil ends that are outside of the slots, conductor of coil end close to the conductor of the heterophase coil having insulating materials at only one of the surfaces, either the inner diameter surface close to the conductor of the heterophase coil or outer diameter surface of the heterophase coil.

### Effects of the Invention

According to the present invention, a dynamo-electric machine with improved insulation reliability at the coil end can be realized using fewer materials and a simplified construction method.

### BRIEF DESCRIPTION OF DRAWINGS

FIG. 1 Cross-sectional perspective view of the dynamo-electric machine in Example 1.

FIG. 2 Perspective view of the anti-junction side of the stator in Example 1.

FIG. 3 This is an enlarged perspective view of the coil end in Example 1.

FIG. 4 Schematic diagram of stator in example 1.

FIG. 5 This is an enlarged view of coil with insulating materials in example 1.

FIG. 6 Schematic diagram of the stator in example 2.

FIG. 7 Enlarged view of the coil with insulating materials in example 2.

FIG. 8 The schematic diagram shows the manner in which creepage discharge between heterophase coils is suppressed in example 2.

FIG. 9 A variation of example 2, showing an example of the arrangement of insulating materials on the coil surface.

FIG. 10 Schematic diagram of the stator in example 3.

FIG. 11 Schematic diagram of the split coil in example 3.

FIG. 12 This is an enlarged view of the coil with insulating materials in example 3.

FIG. 13 Schematic diagram of the stator in example 4.

FIG. 14 Schematic diagram of the split coil in example 4.

FIG. 15 This is an enlarged view of the coil with insulating materials in example 4.

FIG. 16 The schematic diagram shows the manner in which creepage discharge between heterophase coils is suppressed in example 4.

### MODE FOR CARRYING OUT THE INVENTION

The configuration and operation of the radial-gap dynamo-electric machine in Examples 1 through 4 are described below using the drawings.

### Example 1

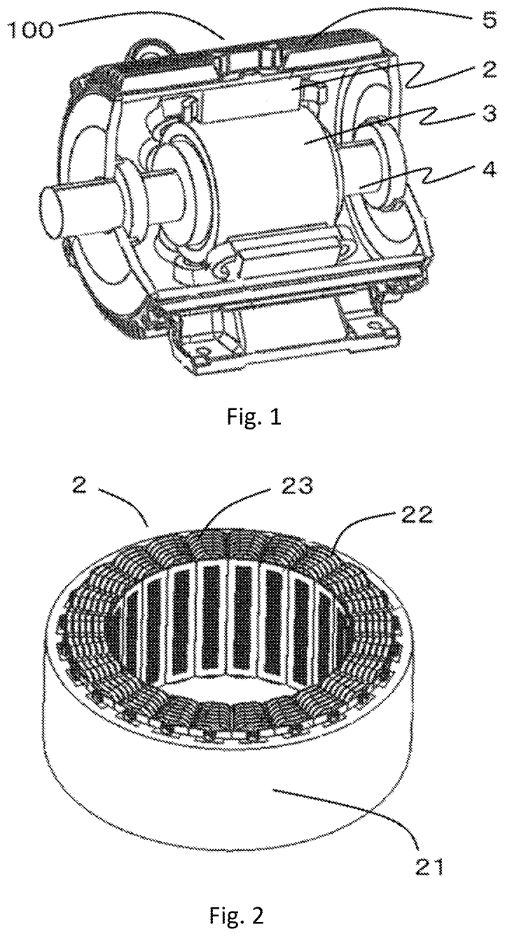

FIG. 1 is a cross-sectional perspective view showing the schematic structure of example 1 dynamo-electric machine. As shown in FIG. 1, dynamo-electric machine 100 is a radial-gap dynamo-electric machine comprising stator 2 and rotor 3. Dynamo-electric machine 100 equip stator 2, rotor 3, shaft 4 and housing 5.

FIG. 2 is a perspective view of the schematic structure of the anti-connection side of stator 2. The connection side having the outlet line of each phase connected to the power supply terminal is the opposite side of FIG. 2. The stator 2 has a stator core 21 with a plurality of slots and a coil 22 with insulation such as insulation coating, coil 22 has a plurality of storages (not shown) that are stored in the slots and a plurality of coil ends 23 that are outside of the slots. The conductors that make up the coil are described using a flat rectangular wire as an example.

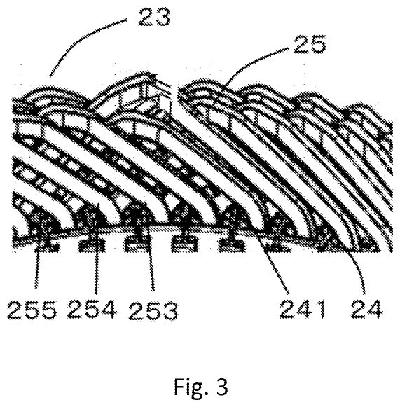

FIG. 3 shows an enlarged perspective view of the coil end. The coil 22 of the coil end 23 is in close proximity at the face 24 (inner diameter face 24) opposite the central axis of the stator core 21, at the face 25 (outer diameter face 25) opposite said face. For example, the inner diameter face 24 of phase U1 241 is close to phase V1 253, phase V2 254, and phase W1 255 at the outer diameter face 25. Although the space between the proximate coils is provided with an insulating film (enamel coating) in advance, there is concern that the initial steep voltage rise and long-term thermal degradation during motor operation may result in dielectric breakdown.

In addition, there are outlet lines for each phase that are connected to the power supply terminals on the connection side of the coil end opposite the anti-connection side.

Since high voltage is applied to the outlet line, there is a concern that insulation breakdown may occur due to the initial steep voltage rise and long-term thermal degradation in the proximity of the heterophase coil as well as the inclined portion of the coil end.

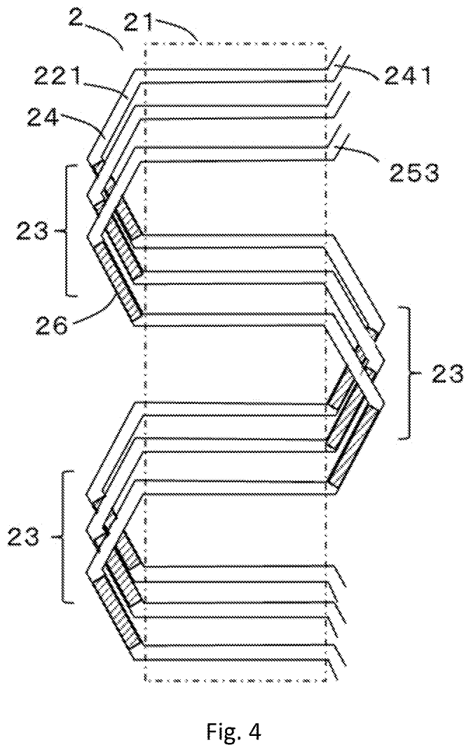

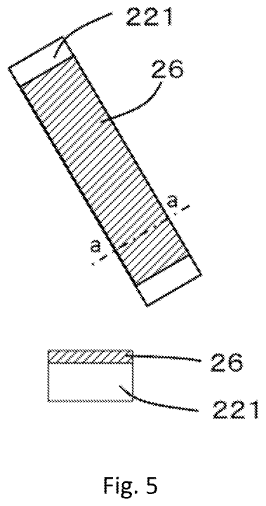

FIG. 4 is a schematic diagram of stator 2 in example 1. FIG. 5 is a schematic diagram showing an enlarged view of the manner in which the insulating materials 26 of the invention are attached to the coil. In FIG. 4, one sloping portion of the inner diameter surface 24 of the coil 221 at the coil end 23 is each equipped with insulating materials 26.

FIG. 5 is an enlarged view of the coil in which insulating materials are placed in example 1. The lower part of FIG. 5 shows a cross-section of the coil 221 in the upper part, cut with the line a-a.

In FIG. 5, the insulating materials are attached to the inner diameter of the coil 24 and the length of the insulating materials 26 is the same as the length of the surface of the coil 221, as shown in the lower a-a section.

The insulating materials 26 are placed at the position where the heterophase coils are close to each other and there is a concern that the insulation strength may decrease. For example, in a U1 phase 241 coil (conductor) among the conductors of coil end 23, insulating materials 26 are provided only on the inside diameter surface 24 where the V1 phase coil 253, which is a different phase, is close to it. This suppresses the decrease in insulation between the two heterophase coils that are close to each other in the radial direction of the coil end 23.

Not limited to the above, for example, the same action and effect can be obtained even if insulating materials 26 are provided only on the outer diameter surface 25 (opposite side of the inner diameter surface) of the conductor at the coil end 23, where the different-phase coils are in close proximity.

Insulating films and insulating resins can be used as insulating materials 26 provided at the coil end of the stator. As insulating films, for example, films or adhesive-backed tapes made of polyethylene terephthalate, polyethylene naphthalate, polyetherimide, polyamide, polyphenylene sulfide, polyetheretherketone, polyimide, etc. can be used. Two of these can be used at the same time. When using insulating film, it can be bonded or adhered to the surface of the target conductor to ensure accurate placement without misalignment during stator assembly.

For example, unsaturated polyester resin, epoxy resin, polyester resin, silicone resin, acrylic resin, and urethane resin can be used as insulating resins. Two of these can be used at the same time. The insulating resin can be prepared by brushing, spraying, molding, or forming on the surface of the target conductor to ensure accurate placement without misalignment during stator assembly.

The surface of the target conductor can be roughened to take advantage of the anchor effect action, which can enhance the adhesiveness and adhesion of the resin in the film.

The above example describes an example with 26 insulating materials on the inclined portion of the coil end.

The same action and effect can be obtained even if the insulating materials 26 are provided on the inner or outer diameter surface of the outlet line that is close to the heterophase coil, as well as on the outlet line of each phase that is connected to the power supply terminal.

The stator 2 of the dynamo-electric machine 100 in this example is equipped with insulating materials 26 only on one of the inner diameter surface 24 or the outer diameter surface 25, where the different phases of coils are close to each other at the coil end 23. This reduces the number of production man-hours and materials, and at the same time, the stator prevents insulation degradation between heterophase coils that are close to each other in the radial direction of the coil end. Therefore, a dynamo-electric machine 100 with high insulation reliability can be provided.

### Example 2

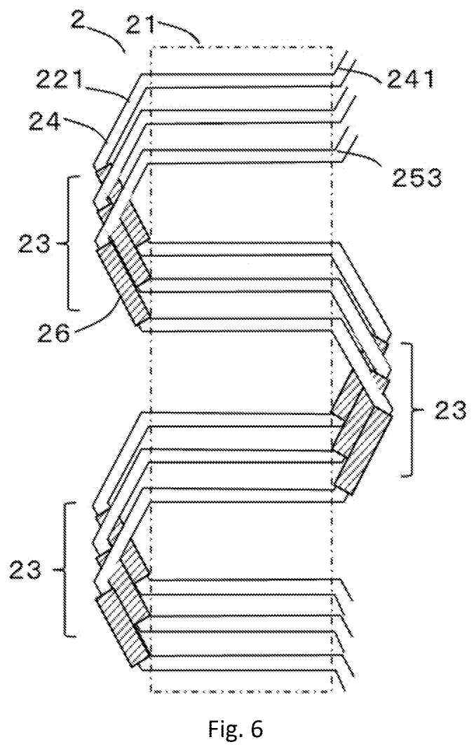

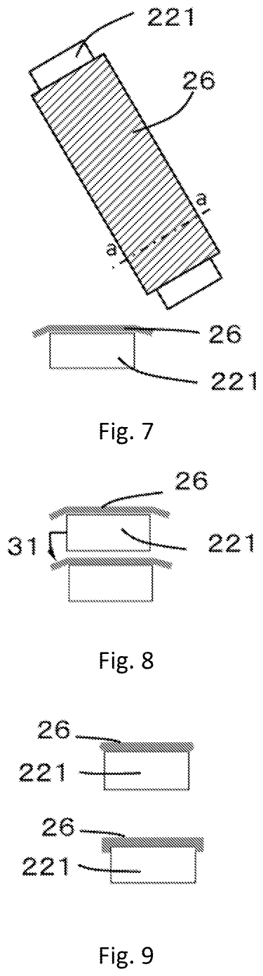

FIG. 6 is a schematic diagram of stator 2 in example 2. FIG. 7 is a schematic diagram showing an enlarged view of the manner in which insulating materials 26 are attached to the coil in this example. In this example, the same details as in example 1 are omitted.

In FIG. 6, one sloping portion of the inner diameter surface 24 of the coil 221 at the coil end 23 is equipped with insulating materials 26 respectively. FIG. 8 is a schematic diagram showing the creepage discharge that occurs in a heterophase coil.

FIG. 9 is a schematic diagram showing the relationship between the dimensions and shape of the insulating materials on the surface of the coil.

FIG. 7 is an enlarged view of the coil in which insulating materials are placed in example 2. The lower part of FIG. 7 shows a cross-section of coil 221 in the upper part, cut with the line a-a.

In FIG. 7, the insulating materials are attached to the inner diameter of the coil 24 and the length of the insulating materials 26 is longer than the length of the surface of the coil 221 as shown in the a-a section. The insulating materials 26 are installed at the position where the heterophase coils are close to each other and there is a concern that the insulation strength will be reduced, i.e., at the coil end 23, for example, at the inner diameter surface 24 where the V1 phase coil 253 is close to the U1 phase 241 coil, which is a different phase. This suppresses the insulation degradation between the two heterophase coils that are close to each other in the radial direction of the coil end.

In FIG. 8, the length of the insulating materials 26 is longer than one of the inner or outer diameter surfaces of the coil 221 in close proximity to the heterophase coil, and the tips of both ends of the insulating materials 26 are inclined downward compared to the insulating materials 26 on the coil 221.

Furthermore, in the proximity between the heterophase coils shown in FIG. 8, the length of the insulating materials 26 is longer than the length of the surface of the coil 221, which suppresses the creepage discharge 31 that occurs between the heterophase coils. The same action and effect can be obtained even if the insulating materials 26 are provided on the outer diameter surface 25, which is the opposite surface of the inner diameter surface, instead of the inner diameter surface.

FIG. 9 is an example of the arrangement of insulating materials 26 on the coil surface. In the upper configuration of FIG. 9, the length of the insulating materials 26 is longer than one of the inner or outer diameter surfaces of the coil 221 in close proximity to the heterophase coil, but unlike FIG. 8,
the tips of both ends of the insulating materials 26 are parallel to the coil 221.

In the lower configuration of FIG. 9, the tips of both ends of the insulating materials 26 are configured to extend not only on one surface of the coil 221 (the top surface in the figure), but also on portions of the surfaces of two surfaces in the direction of the thickness of the coil 221. This configuration is a configuration in which the insulating materials 26 are arranged on three surfaces of the coil 221 together with the top surface. The arrangement of insulating materials 26 in FIG. 9 has the same effect as the insulating materials in FIG. 8. However, placing the insulating materials 26 on only one surface of the coil 221 reduces the number of insulating materials and the man-hours required, compared to having the insulating materials 26 on three surfaces.

The same insulating materials 26 can be used as in example 1, and similarly, the surface of the target conductor can be roughened to take advantage of the anchor effect action, thereby enhancing the adhesiveness and adhesion of the resin in the film.

The stator 2 of the dynamo-electric machine 100 in this example is provided with insulating materials 26 only on the inner diameter surface 24 or the outer diameter surface 25, where the different phases of the coil at the coil end 23 are close to each other, and these insulating materials the width of the insulating materials 26 should be larger than the width of the inner diameter surface 24 or the outer diameter surface 25. This reduces the number of production man-hours and materials, and at the same time, the stator can be obtained by preventing insulation degradation between interconnecting heterophase coils that are close to each other in the radial direction of the coil end and due to creepage discharge. Therefore, a dynamo-electric machine 100 with higher insulation reliability can be provided.

### Example 3

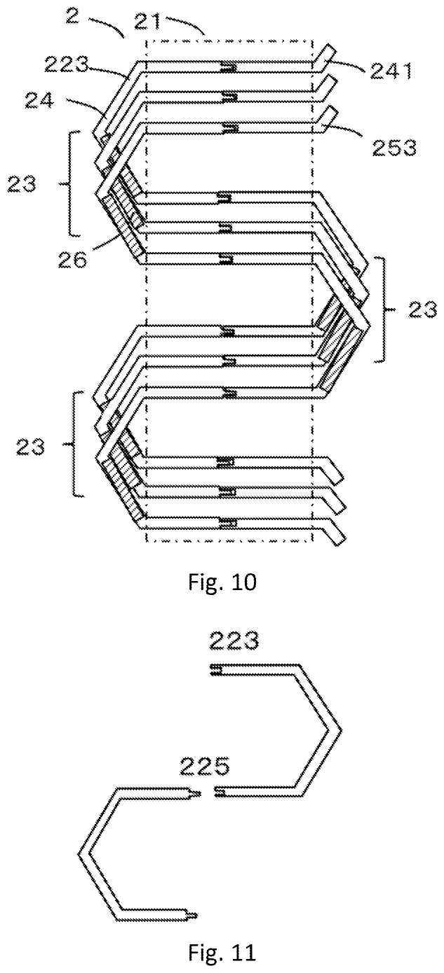

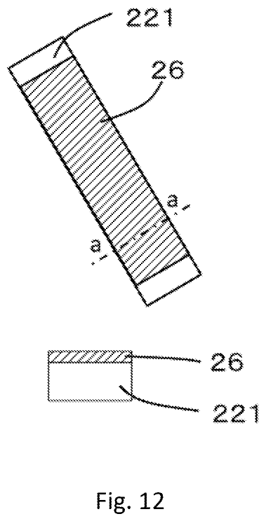

FIG. 10 is a schematic diagram of stator 2 in example 3. FIG. 11 is a schematic diagram of a split coil. FIG. 12 is an enlarged schematic diagram of the insulating materials 26 attached to the coil in this example. In this example, the same details as in the above examples are omitted.

The split coil 223 shown in FIG. 10 is connected to the coil storage in the slot so that the uneven part 225 shown in FIG. 11 is continuous in the slot.

FIG. 12 is an enlarged view of the coil in which insulating materials are placed in example 3. The lower part of FIG. 12 shows a cross-section of coil 221 in the upper part, cut with the line a-a.

In FIG. 12, one slope of the inner diameter surface 24 of coil 221 at coil end 23 is provided with insulating materials 26 respectively. Further insulating materials are attached to the inner diameter of the coil 24, and as shown in the a-a section, the length of the insulating materials 26 is the same as the length of the surface of the coil 221.

The insulating materials 26 are provided at the position where the heterophase coils are close to each other and there is a concern that the insulation strength may decrease, i.e., at the coil end 23, for example, insulating materials 26 are provided at the bore surface 24 where the V1 phase coil 253 is close to the U1 phase 241 coil, which is a different phase. This suppresses the decrease in insulation between the two interphase coils that are close to each other in the radial direction of the coil end. The same action and effect can be obtained even if the insulating materials 26 are provided on the outer diameter surface 25, which is the opposite side of the inner diameter surface, instead of the inner diameter surface.

The split coil 223 can be connected to the part with insulating materials 26 without passing the split coil 223 through the slot. There is no need to place the insulating materials 26 in the storage area of the coil in this example. Therefore, the stator can be fabricated with the smallest dimensional design without providing a margin in the slot for passing the insulating materials 26.

The same insulating materials 26 can be used as in example 1, and similarly, the surface of the target conductor can be roughened to take advantage of the anchor effect action, thereby enhancing the adhesiveness and adhesion of the resin in the film.

According to this example, the electrical insulation between different-phase conductors and between conductor creepage surfaces at the coil end can be improved without compromising the productivity of the stator, thus improving the insulation reliability of the stator and dynamo-electric machine.

The stator 2 of the dynamo-electric machine 100 in this example is equipped with insulating materials 26 only on the inner diameter surface 24 or the outer diameter surface 25, where the different phases of coils at the coil end 23 are close to each other.

The stator can be manufactured with the minimum dimensional design without any margin in the dimensions inside the slot. This reduces the number of production man-hours and materials, and the diameter of the coil end of the stator can be reduced in the radial direction, resulting in a stator that prevents insulation degradation between neighboring interconnecting heterophase coils. Thus, a dynamo-electric machine 100 with smaller size and higher insulation reliability can be provided.

### Example 4

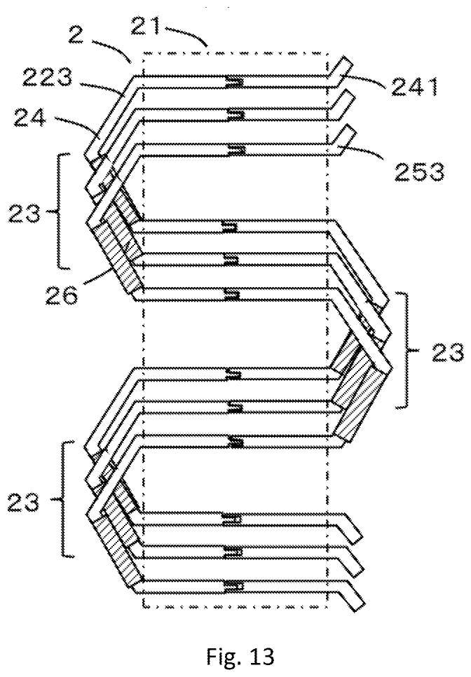

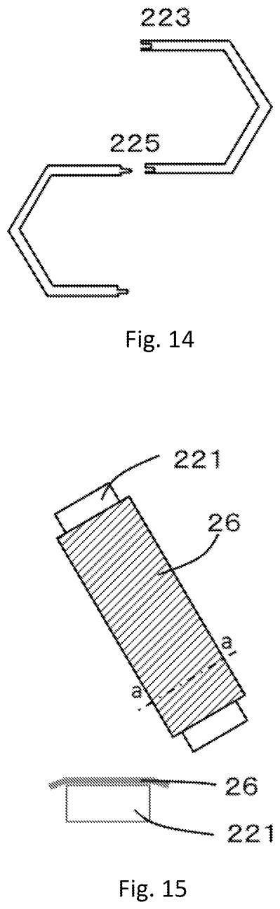

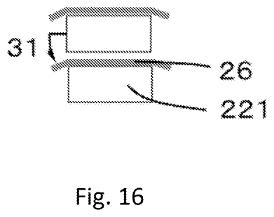

FIG. 13 is a schematic diagram of stator 2 in example 4. FIG. 14 is a schematic diagram of a split coil. FIG. 15 is an enlarged schematic diagram of the insulating materials 26 attached to the coil in this example. FIG. 16 is a schematic diagram of the suppression of creepage discharge that occurs in a heterophase coil. In this example, the same details as in the above examples are omitted.

The split coil 223 shown in FIG. 13 is connected so that the coil storage in the slot is continuous with the uneven part 225 shown in FIG. 14 in the slot.

FIG. 15 is an enlarged view of the coil with insulating materials in example 4. The lower part of FIG. 15 shows a cross-section of the coil 221 in the upper part, cut with the line a-a.

In FIG. 15, the insulating materials are attached to the inner diameter of the coil 24 and the length of the insulating materials 26 is longer than the length of the surface of the coil 221 as shown in the a-a section.

The insulating materials 26 are installed at the position where the heterophase coils are close to each other and there is a concern that the insulation strength will be reduced, i.e., at the coil end 23, for example, the insulating materials 26 are provided at the inner diameter surface 24 where the V1 phase coil 253 is close to the U1 phase 241 coil, which is a different phase.

This suppresses the insulation between interconnecting heterophase coils in the radial direction of the coil end, and as shown in FIG. 16, the length of the insulating materials 26 is longer than the length of the surface of the coil 221, which suppresses the creepage discharge 31 that occurs between interconnecting heterophase coils.

The same action and effect can be obtained even if the insulating materials 26 are provided on the outer diameter surface 25, which is the opposite surface of the inner diameter surface, instead of the inner diameter surface.

In addition, since the split coil 223 can be connected in the slot without passing the part equipped with insulating materials 26 through the slot, the stator can be manufactured with the smallest dimensional design without providing a margin in the slot for passing the insulating materials 26. Therefore, the stator can be fabricated with a minimum dimensional design without providing a margin in the slot to pass through the insulating materials 26.

The same insulating materials 26 can be used as in example 1, and similarly, the surface of the target conductor can be roughened to take advantage of the anchor effect action, thereby enhancing the adhesiveness and adhesion of the resin in the film.

The stator 2 of the dynamo-electric machine 100 in this example is provided with insulating materials 26 only on the inner diameter surface 24 or the outer diameter surface 25, where the different phases of the coil at the coil end 23 are close to each other, and these insulating materials The width of the insulating materials 26 shall be larger than the width of the inner diameter surface 24 or the outer diameter surface 25.

According to this example, the number of production man-hours and materials can be reduced, the diameter of the coil end can be reduced in the radial direction, and a stator can be obtained that prevents insulation degradation due to the proximity of heterophase coils in the radial direction of the coil end and creepage discharge. Therefore, a dynamo-electric machine 100 with smaller size and higher insulation reliability can be provided.

In the above example, the conductor of COIL is described using a flat rectangular wire as an example, but COIL conductor may be used as a bundle of multiple round wires in a rectangular cross-sectional shape.

### REFERENCE SIGNS LIST

100 . . . dynamo-electric machine
2 . . . stator
3 . . . rotor
4 . . . shaft
5 . . . housing
6 . . . bearing
21 . . . stator core
22 . . . coil
221 . . . coil
223 . . . split coil
225 . . . uneven part
23 . . . coil end
24 . . . inner diameter surface of coil
25 . . . outer diameter surface of coil
26 . . . insulating materials
31 . . . creepage discharge

1. A dynamo-electric machine comprising:
a stator core with plurality of slots,
a coil covered with insulated conductor wire,
wherein the coil comprising plurality of storages stored in the slots and plurality of coil ends that are outside of the slots,
conductor of coil end close to the conductor of the heterophase coil having insulating materials at only one of the surfaces, either the inner diameter surface close to the conductor of the heterophase coil or outer diameter surface of the heterophase coil.

2. A dynamo-electric machine according to claim 1,
the conductor is a flat rectangular wire.

3. A dynamo-electric machine according to claim 1,
the conductors is a round wire.

4. A dynamo-electric machine according to claim 1,
the length of said insulating materials is the same as the length of the surface of the conductor.

5. A dynamo-electric machine according to claim 1,
the length of said insulating materials is longer than the length of the conductor surface.

6. A dynamo-electric machine according to claim 5,
the insulating materials are attached to only one surface of said conductor.

7. A dynamo-electric machine according to claim 5,
the insulating materials are further attached to a portion of the conductor in the direction of its thickness.

8. A dynamo-electric machine according to claim 1,
the coil can be connected in the storage.

9. A dynamo-electric machine according to claim 1,
the conductors are outlet line of each phase that are connected to the power supply terminals.

10. A dynamo-electric machine according to claim 1,
the conductors are coated with enamel.
